(19) United States
(12) Patent Application Publication
(10) Pub. No.: US 2026/0244127 A1
(43) Pub. Date: Aug. 20, 2026

(54) IMAGE FORMING APPARATUS

(71) Applicant: CANON KABUSHIKI KAISHA, Tokyo (JP)

(72) Inventors: MOTOYA YAMADA, Chiba (JP); HARUKI MORI, Chiba (JP); SHOTA INOUE, Ibaraki (JP)

(21) Appl. No.: 19/534,991

(22) Filed: Feb. 10, 2026

(30) Foreign Application Priority Data
Feb. 18, 2025 (JP) 2025-024533
Nov. 21, 2025 (JP) 2025-201776

(51) Int. Cl. G03G 15/16

(52) U.S. Cl. CPC G03G 15/1605; G03G 15/161; G03G 15/1615; G03G 15/162; G03G 2215/0132

(57) ABSTRACT

An image forming apparatus comprising at least an electrophotographic photosensitive member and transfer means for transferring a toner image from a surface of the electrophotographic photosensitive member to a transfer member, wherein the electrophotographic photosensitive member has a photosensitive member surface layer formed using amorphous silicon carbide or amorphous carbon, in a near surface region of the photosensitive member surface layer, a ratio of the number of carbon atoms to a total number of the carbon atoms and silicon atoms is 0.85 or more, the transfer member is an intermediate transfer belt comprising at least a transfer member surface layer, and the transfer member surface layer comprises a first resin that comprises a silicone-acrylic polymer or a silicone-vinyl acetate polymer and a second resin that comprises a urethane resin.

### BACKGROUND

### Field of the Technology

The present disclosure relates to an image forming apparatus.

### Description of the Related Art

An image forming method of an electrophotographic system (hereinafter, also simply referred to as an “image forming method”) and an electrophotographic image forming apparatus using this (hereinafter, also simply referred to as an “image forming apparatus”) are widely and generally used as a copier, a facsimile machine, and a printer. In such an image forming apparatus, an electrostatic latent image is formed on the surface of an electrophotographic photosensitive member by uniformly charging the surface of the electrophotographic photosensitive member and then performing exposing by using a laser or an LED according to image information. Next, toner is attached to the formed electrostatic latent image so as to form a toner image on the surface of the electrophotographic photosensitive member, and this toner image is transferred to a transfer paper such as paper, whereby image formation is performed.

In a situation in which high-quality color printing is required, a tandem system is widely used, in which toner images of colors of yellow (Y), magenta (M), cyan (C), and black (K) are superimposed on an intermediate transfer belt and then are transferred altogether to a transfer paper to acquire a full-color image.

As an electrophotographic photosensitive member that can be appropriately used for such an image forming apparatus, an amorphous silicon electrophotographic photosensitive member (hereinafter also represented as an “a-Si photosensitive member”) is known. Various materials and layer structures have conventionally been proposed for the surface layer of the a-Si photosensitive member, and a surface layer using an amorphous silicon-based material or amorphous silicon carbide (hereinafter also represented as “a-SiC”) comprising carbon (C) exhibits excellent electrical characteristics, image characteristics, and durability based on high hardness thereof.

Additionally, as a transfer member used for improving transferability for heavy paper or paper with unevenness, an intermediate transfer belt having an elastic layer in at least one layer in a layer structure (hereinafter also represented as an elastic intermediate transfer belt) is known.

In recent years, improved image characteristics and durability have been required in image forming apparatuses, and, for example, in Japanese Patent Publication No. 2012-032503, a technique for improving image characteristics and durability by using amorphous carbon (hereinafter also represented as “a-C”) comprising a large amount of carbon (C) on the outermost surface is described.

In addition, in Japanese Patent Publication No. 2004-198713, a technique for causing a fluoro-resin to be comprised in the surface layer of an elastic intermediate transfer belt in order to implement excellent toner releasability is described.

However, even in a case in which the electrophotographic photosensitive member described in Japanese Patent Publication No. 2012-032503 and the elastic intermediate transfer belt described in Japanese Patent Publication No. 2004-198713 are used in combination, it has been found that there is still room for improvement in transferability for paper with unevenness at the time of repeated use under a low-humidity environment. In other words, it has been ascertained that there are cases in which the transferability is reduced due to electric charge generated in accordance with triboelectric charging between the electrophotographic photosensitive member and the elastic intermediate transfer belt.

### SUMMARY

The present disclosure is for providing an image forming apparatus that exhibits excellent transferability for paper with unevenness in a low-humidity environment and suppresses reduction of transferability at the time of repeated use under this environment.

At least one aspect of the present disclosure is directed to providing an image forming apparatus comprising:
an electrophotographic photosensitive member;
charging means for charging a surface of the electrophotographic photosensitive member;
image exposing means for forming an electrostatic latent image on the surface of the electrophotographic photosensitive member by emitting image exposure light to the surface of the charged electrophotographic photosensitive member;
toner;
developing means for forming a toner image on the surface of the electrophotographic photosensitive member by developing the electrostatic latent image by using the toner;
transfer means for transferring the toner image from the surface of the electrophotographic photosensitive member to a transfer member; and
cleaning means for removing residual toner remaining on the surface of the electrophotographic photosensitive member,
wherein the electrophotographic photosensitive member has a photosensitive member surface layer formed of amorphous silicon carbide or amorphous carbon,
wherein, in a surface region A that is a region near the surface from the surface of the photosensitive member surface layer to a depth of 100 nm, a ratio of the number of carbon atoms to a sum of the number of carbon atoms and the number of silicon atoms is 0.85 or more,
wherein the transfer member is an intermediate transfer belt comprising a substrate layer, an elastic layer, and a transfer member surface layer,
wherein the transfer member surface layer comprises a first resin and a second resin,
wherein the first resin comprises at least one selected from the group consisting of a silicone-acrylic polymer having a silicone segment and an acrylic polymer segment; and a silicone-vinyl acetate polymer having a silicone segment and a vinyl acetate polymer segment; and
wherein the second resin comprises a urethane resin.

According to one aspect of the present disclosure, an image forming apparatus that exhibits excellent transferability for paper with unevenness in a low-humidity environment and suppresses reduction of transferability at the time of repeated use under this environment can be provided.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view representing an example of an image forming apparatus.

FIG. 2 is a schematic view representing an example of a layer structure of an electrophotographic photosensitive member included in an image forming apparatus.

FIG. 3 is a schematic view illustrating an example of a deposition apparatus according to an RF plasma CVD method using a high-frequency power supply that can be used for producing an electrophotographic photosensitive member.

FIG. 4 is a schematic view illustrating an example of a layer structure of a transfer member included in an image forming apparatus.

### DESCRIPTION OF THE EMBODIMENTS

The inventors of the present disclosure assume the reason for reduction of the transferability for paper with unevenness at the time of repeated use under a low-humidity environment in an image forming apparatus, which is acquired by combining the electrophotographic photosensitive member described in Japanese Patent Publication No. 2012-032503 and the elastic intermediate transfer belt described in Japanese Patent Publication No. 2004-198713, to be as follows.

In the electrophotographic photosensitive member described in Japanese Patent Publication No. 2012-032503, the surface layer is formed of a-SiC or a-C comprising a large amount of carbon (C), and thus, many carbon atoms are present on the surface of the electrophotographic photosensitive member. In addition, since the elastic intermediate transfer belt described in Japanese Patent Publication No. 2004-198713 comprises a fluoro-resin in its surface layer, many fluorine atoms are present on the surface of the elastic intermediate transfer belt. When the electrophotographic photosensitive member and the elastic intermediate transfer belt rub against each other, electric charges may be generated due to triboelectric charging. In accordance with the relation of triboelectric series, it becomes easy for the surface of the electrophotographic photosensitive member to be positively charged and the surface of the elastic intermediate transfer belt to be negatively charged.

For this reason, in the image forming apparatus described above, it is assumed that, for example, charge generated in a yellow (Y) image forming unit causes abnormal discharge on the surface of the elastic intermediate transfer belt or changes the charge of toner in a magenta (M) image forming unit of the next process to easily deteriorate the transferability.

The above-described deterioration of the transferability caused by charges generated through triboelectric charging is a phenomenon that can occur regardless of the charging polarity of a charging means of the image forming apparatus, and this effect becomes significant in a low-humidity environments or a high-speed image forming apparatus in which charge may be easily generated in accordance with rubbing. Furthermore, an electrophotographic photosensitive member having a surface layer formed of a-SiC or a-C that comprises more carbon (C) than the surface of an organic photosensitive member may easily generate a triboelectric series with the surface of the elastic intermediate transfer belt comprising a fluoro-resin, and the effect becomes even more significant.

According to reviews of the inventors of the present disclosure, it has been found that this effect becomes particularly significant in an electrophotographic photosensitive member having a surface layer in which the ratio of the number of carbon atoms to a sum of the number of carbon atoms and the number of silicon atoms in a near-surface region extending to a depth of 100 nm from the surface (surface region A) is 0.85 or more.

Accordingly, the inventors of the present disclosure have found that an electrophotographic apparatus that exhibits excellent transferability in a low-humidity environment and can suppress deterioration of the transferability at the time of repeated use under the same environment can be provided by configuring the surface layer of the intermediate transfer belt to comprise a first resin and a second resin in which the first resin comprises a silicone-acrylic polymer having silicone segments and acrylic polymer segments or a silicone-vinyl acetate polymer having silicone segments and vinyl acetate polymer segments, and the second resin comprises a urethane resin.

On the surface of the intermediate transfer belt of the present disclosure, the first resin comprises a silicone-acrylic polymer or a silicone-vinyl acetate polymer having silicone segments that comprise a large amount of silicon atoms. In accordance with this, a triboelectric series difference from the surface of the electrophotographic photosensitive member, which comprises a large amount of carbon, is reduced, thus, the generation of charges according to triboelectric charging can be suppressed, and thus, it is assumed that an image forming apparatus in which deterioration of transferability at the time of repeated use under a low-humidity environment is suppressed can be provided. Furthermore, according to the configuration described above, wear resistance, media conformity, toner releasability, and the like can also be maintained in a practically acceptable range.

Hereinafter, the present disclosure is described in detail using a preferred embodiment.

### Image Forming Apparatus

An image forming apparatus according to the present disclosure is described.

The image forming apparatus has a charging means for charging a surface of an electrophotographic photosensitive member, and an image exposing means for forming an electrostatic latent image on the surface of the electrophotographic photosensitive member by emitting image exposure light to the surface of the charged electrophotographic photosensitive member. In addition, the image forming apparatus has a toner and a developing means for forming a toner image on the surface of the electrophotographic photosensitive member by developing the electrostatic latent image by using toner. Further, the image forming apparatus has a transfer means for transferring the toner image from the surface of the electrophotographic photosensitive member to a transfer member and a cleaning means for removing residual toner remaining on the surface of the electrophotographic photosensitive member.

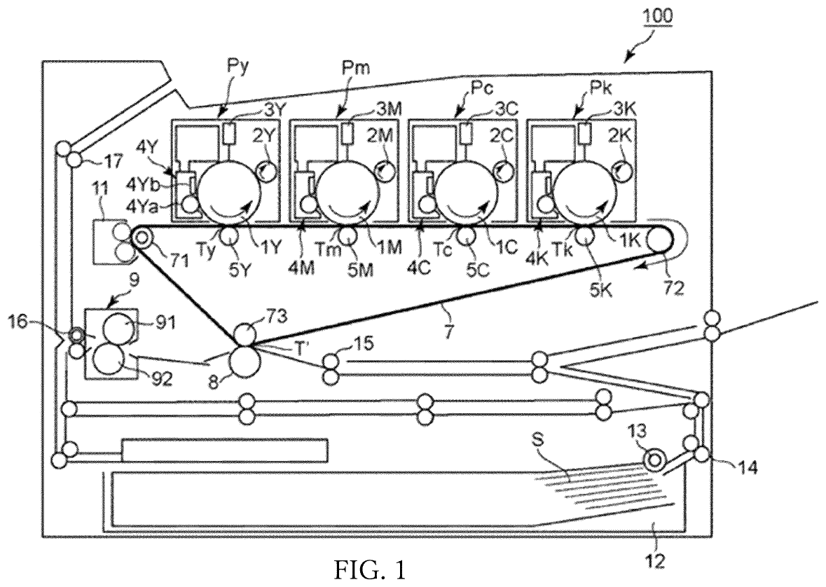

FIG. 1 illustrates an example of the configuration of an image forming apparatus according to the present disclosure. An image forming apparatus 100 comprises an electrophotographic photosensitive member and an intermediate transfer belt. Along a flat portion of an intermediate transfer belt 7, image forming units Py, Pm, Pc, and Pk of colors of yellow (Y), magenta (M), cyan (C), and black (K) are sequentially disposed in the moving direction thereof.

In FIGS. 1, 1Y, 1M, 1C, and 1K denote electrophotographic photosensitive members, 2Y, 2M, 2C, and 2K denote charging rollers for charging the surfaces of the electrophotographic photosensitive members, 3Y, 3M, 3C, and 3K denote laser exposure devices for forming electrostatic latent images on the surfaces of the electrophotographic photosensitive members, 4Y, 4M, 4C, and 4K denote developing devices for forming toner images on the surfaces of the electrophotographic photosensitive members by developing electrostatic latent images using toner, and 5Y, 5M, 5C, and 5K denote primary transfer rollers for transferring the toner images from the surfaces of the electrophotographic photosensitive members to the surface of the intermediate transfer belt.

The basic configurations of the image forming units Py, Pm, Pc and Pk are the same, and thus, details of the image forming units are described using the yellow image forming unit Py as an example.

The yellow image forming unit Py comprises an electrophotographic photosensitive member 1Y.

The yellow image forming unit Py comprises a charging roller 2Y as a charging means. By applying a charging bias to the charging roller 2Y, the surface of the electrophotographic photosensitive member 1Y is uniformly charged. A laser exposing device 3Y as an image exposing means is disposed above the electrophotographic photosensitive member 1Y. The laser exposing device 3Y scans and exposes the surface of the electrophotographic photosensitive member 1Y, which has been uniformly charged, in accordance with image information and forms an electrostatic latent image of the yellow component on the surface of the electrophotographic photosensitive member 1Y.

The electrostatic latent image formed on the electrophotographic photosensitive member 1Y is developed by the developing device 4Y as a developing means using toner as a developing agent. In other words, the developing device 4Y comprises a developing roller 4Ya that is a developing agent carrying member and a regulating blade 4Yb that is a member regulating the amount of the developing agent and houses yellow toner that is a developing agent.

The developing roller 4Ya supplied with yellow toner is brought into light pressure contact with the electrophotographic photosensitive member 1Y in the developing portion and rotated in a forward direction with a speed difference with respect to that of the electrophotographic photosensitive member 1Y. The yellow toner conveyed to the developing portion by the developing roller 4Ya adheres to the electrostatic latent image formed on the electrophotographic photosensitive member 1Y by applying a developing bias to the developing roller 4Ya. In accordance with this, a yellow toner image is formed on the electrophotographic photosensitive member 1Y.

The intermediate transfer belt 7 is stretched around a driving roller 71, a tension roller 72, and a driven roller 73 and is moved (rotated) in the direction indicated by an arrow in the drawing in contact with the electrophotographic photosensitive member 1Y.

The yellow toner image formed on the electrophotographic photosensitive member 1Y that has arrived at a primary transfer portion Ty is primarily transferred onto the intermediate transfer belt 7 by the primary transfer roller 5Y arranged to face the electrophotographic photosensitive member 1Y through the intermediate transfer belt 7.

Similarly, the image forming operation described above is performed by the image forming units Pm, Pc, and Pk of magenta (M), cyan (C), and black (K) in accordance with the movement of the intermediate transfer belt 7, whereby toner images of four colors of yellow, magenta, cyan, and black are stacked on the intermediate transfer belt 7.

The toner layers of the four colors are conveyed in accordance with the movement of the intermediate transfer belt 7 and, in a secondary transfer portion T′, are transferred altogether onto a transfer paper S conveyed at a predetermined timing by a secondary transfer roller 8 as a secondary transfer means. In such secondary transfer, commonly, a transfer voltage of several kV is applied in order to secure a sufficient transfer rate.

The transfer paper S is supplied from a cassette 12 in which the transfer paper S is housed to a conveyance path by a pick-up roller 13. The transfer paper S fed to the conveyance path is conveyed up to the secondary transfer portion T′ in synchronization with the toner images of four colors that have been transferred to the intermediate transfer belt 7 by a conveyance roller pair 14 and a registration roller pair 15.

The toner image transferred onto the transfer paper S is fixed by the fixing unit 9, for example, to form a full-color image. The fixing unit 9 has a fixing roller 91 having a heating means and a pressing roller 92 and fixes an unfixed toner image on the transfer paper S by heating and pressing it. Thereafter, the transfer paper S is discharged to the outside of the apparatus by a pair of conveyance rollers 16, a pair of discharge rollers 17, and the like.

A cleaning unit 11 of the intermediate transfer belt 7 is disposed downstream of a second transfer portion T′ in the driving direction of the intermediate transfer belt 7 and removes residual toner which has not been transferred to the transfer paper S in the second transfer portion T′ and remains on the intermediate transfer belt 7.

As described above, electrical transfer processes of the toner image from the electrophotographic photosensitive member to the intermediate transfer belt and from the intermediate transfer belt to the transfer paper are repeatedly performed. By repeating recording for a large number of transfer papers, the electrical transfer processes are further repeated.

### Electrophotographic Photosensitive Member

The electrophotographic photosensitive member at least has a photosensitive member surface layer formed of amorphous silicon carbide or amorphous carbon. By forming the photosensitive member surface layer using the above-described amorphous silicon carbide or amorphous carbon, the hardness of the photosensitive member surface layer is increased, and the wear resistance thereof is improved.

The electrophotographic photosensitive member may comprise a conductive substrate, a pressure-resistant layer formed on the substrate, a charge injection blocking layer formed on the pressure-resistant layer, a photoconductive layer formed on the charge injection blocking layer, an upper injection blocking layer formed on the photoconductive layer, and the above-described photosensitive member surface layer formed on the upper injection blocking layer.

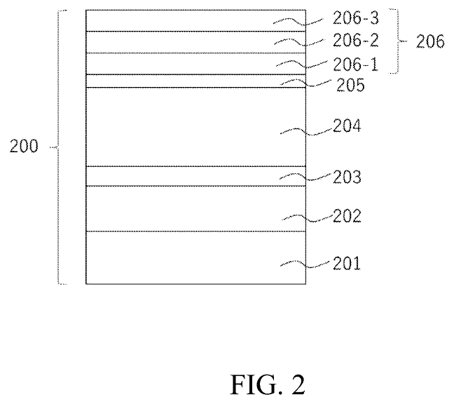

FIG. 2 is a schematic view illustrating an example of a layer structure of an electrophotographic photosensitive member.

The electrophotographic photosensitive member 200 illustrated in FIG. 2 has a pressure-resistant layer 202, a charge injection blocking layer 203, a photoconductive layer 204, an upper injection blocking layer 205, and a photosensitive member surface layer 206 on a conductive substrate 201.

Next, the conductive substrate 201 and each layer constituting the electrophotographic photosensitive member are described.

### Conductive Substrate

It is preferable that the material of the conductive substrate 201 should be a material forming a Schottky junction with the pressure-resistant layer 202 that is directly formed on the surface of the conductive substrate. For example, a metal material such as aluminum (Al), stainless steel (SUS), zinc (Zn), copper (Cu), iron (Fe), titanium (Ti), nickel (Ni), chromium (Cr), tantalum (Ta), tin (Sn), gold (Au) or silver (Ag), or an alloy material comprising such a metal material can be used. For example, in a case in which hydrogenated amorphous silicon nitride (hereinafter also referred to as a-SIN:H) is applied to the material of the pressure-resistant layer 202, an alloy comprising aluminum as its main component is an example of appropriate materials.

The shape of the conductive substrate is, for example, cylindrical shape. As the cylindrical conductive substrate, for example, a raw aluminum alloy tube or the like can be used. In addition, a raw tube made of the metal material or the alloy material described above can be used.

The surface of the conductive substrate may be roughened. A surface roughness Sa of the conductive substrate after roughening may be, for example, from 80 to 120 nm. In accordance with this, for example, in a case in which each layer is formed as a film using a plasma CVD method, an electrophotographic photosensitive member of which the arithmetic mean value of the surface roughness Sa is from 80 to 120 nm can be acquired, which is preferable.

As a method for roughening the surface of a conductive substrate, for example, wet blasting, sputter etching, gas etching, polishing, turning, wet etching, galvanic corrosion, or the like may be used. Before the roughening of the surface of the conductive substrate, a pretreatment such as a mirror surface treatment or a degreasing treatment may be performed as needed. In the case of a drawing pipe that satisfies the surface roughness described above, it can be used as it is without performing a surface treatment for adjusting the surface shape.

### Pressure-Resistant Layer

In an electrophotographic process, a voltage having a polarity opposite to the charging polarity of an electrophotographic photosensitive member may be applied in a developing process, a transfer process, or the like. The pressure-resistant layer 202 is a layer that suppresses dielectric breakdown of the electrophotographic photosensitive member when a voltage having a polarity opposite to the charging polarity of the electrophotographic photosensitive member is applied thereto.

It is preferable that the pressure-resistant layer should be formed of a-SiN:H. The pressure-resistant layer may comprise oxygen atoms and hydrogen atoms. Furthermore, in order to improve adhesiveness for a conductive substrate, a carbon atom or the like may be comprised.

### Charge Injection Blocking Layer

The charge injection blocking layer 203 has a function of blocking the injection of charges from the conductive substrate 201 side into the photoconductive layer 204.

It is preferable that the charge injection blocking layer should be formed of hydrogenated amorphous silicon (hereinafter also referred to as a-Si:H).

It is preferable that the material of the charge injection blocking layer should be on the basis of a material constituting the photoconductive layer and comprise more atoms for controlling the conductivity than the photoconductive layer.

Examples of atoms comprised in the charge injection blocking layer for controlling the conductivity include so-called impurities in the field of semiconductors. Atom belonging to group 13 of the periodic table giving p-type conductivity (hereinafter also referred to as “Group 13 atoms”) or atoms belonging to group 15 of the periodic table giving n-type conductivity (hereinafter also referred to as “Group 15 atoms”) can be used in accordance with the charge polarity. Furthermore, it is not necessarily essential to dope impurities atoms in the charge injection blocking layer, and by optimally introducing nitrogen (N), carbon (C) and oxygen (O) thereinto, a charge injection blocking capability may be provided.

More specifically, examples of Group 13 atoms comprised in the charge injection blocking layer of a photosensitive member for positive charging include boron (B), aluminum (Al), gallium (Ga), indium (In), thallium (TI), and the like. Boron (B) is particularly appropriate.

More specifically, examples of Group 15 atoms comprised in the charge injection blocking layer of a photosensitive member for negative charging include P (phosphorus), As (arsenic), Sb (antimony), and Bi (bismuth). P (phosphorus) and As (arsenic) are particularly appropriate.

It is preferable that the content of Group 13 atoms or Group 15 atoms comprised in the charge injection blocking layer should be from 1×10² to 3×10³ atom ppm with respect to the content of silicon atoms (Si) comprised in the charge injection blocking layer.

The Group 13 atoms or the Group 15 atoms may be comprised in a uniformly-distributed state without remaining in the charge injection blocking layer or may have a part comprised in an unevenly-distributed state in a film thickness direction. In either case, it is preferable from the viewpoint of achieving uniformization of characteristics that atoms for controlling conductivity should be comprised in the charge injection blocking layer in a uniform distribution in an in-plane direction parallel to the surface of the substrate.

Furthermore, by causing the charge injection blocking layer to comprise at least one kind of atoms among carbon atoms, nitrogen atoms and oxygen atoms, the adhesiveness between the charge injection blocking layer and the pressure-resistant layer can be improved.

### Photoconductive Layer

It is preferable that the photoconductive layer 204 should be formed of a-Si:H. Furthermore, it is preferable that the photoconductive layer should comprise hydrogen atoms in order to compensate for non-bonded hands.

It is preferable that the photoconductive layer should comprise atoms for controlling the conductivity as necessary. The atoms for controlling the conductivity may be comprised in a uniformly-distributed state without remaining in the photoconductive layer or may have a part comprised in an unevenly-distributed state in a film thickness direction.

Examples of the atoms for controlling the conductivity include so-called impurities in the field of semiconductors. In other words, Group 13 atoms or Group 15 atoms can be used. Among the Group 13 atoms, boron atoms (B), aluminum atoms (Al), and gallium atoms (Ga) are preferable. Among the Group 15 atoms, phosphorus atoms (P) and arsenic atoms (As) are preferable. The photoconductive layer may comprise carbon atoms, oxygen atoms, nitrogen atoms, and the like.

It is preferable that the content of atoms for controlling the conductivity, which are comprised in the photoconductive layer, should be 1×10⁻² atom ppm or more with respect to silicon atoms (Si). On the other hand, it is preferable that the content should be 1×10 atom ppm or less.

The photoconductive layer may be configured as a single layer or may be configured as multiple layers (for example, a charge generation layer and a charge transport layer).

### Upper Injection Blocking Layer

Between the photoconductive layer and the photosensitive member surface layer, an upper injection blocking layer having a function of blocking injection of charges from the photosensitive member surface layer side may be provided. It is preferable that the upper injection blocking layer of the electrophotographic photosensitive member should be formed of a-Si:H. It may also comprise carbon (C), nitrogen (N), and oxygen (O).

The upper injection blocking layer has a function of blocking injection of charges by further comprising atoms for controlling the conductivity.

Examples of the atoms for controlling the conductivity include so-called impurities in the field of semiconductors. In the case of a photosensitive member for negative charging in which the polarity of the electrophotographic photosensitive member is negative, Group 13 atoms giving p-type conductivity can be used.

More specifically, the Group 13 atoms include boron (B), aluminum (Al), gallium (Ga), indium (In), thallium (TI), and the like. Boron (B) is particularly appropriate.

It is preferable that the content of Group 13 atoms or Group 15 atoms comprised in the upper injection blocking layer should be from 1×10² to 1×10³ atom ppm with respect to the content of silicon atoms (Si) comprised in the upper injection blocking layer.

### Photosensitive Member Surface Layer

The photosensitive member surface layer 206 is formed of amorphous silicon carbide (a-SiC) or amorphous carbon (a-C). The a-SiC and a-C may comprise impurities more or less. As the impurities, for example, the Group 13 atoms or the Group 15 atoms described above or the like can be used.

It can be checked that the photosensitive member surface layer 206 is formed of amorphous silicon carbide (a-SiC) or amorphous carbon (a-C) by combining an X-ray diffraction method and a Raman spectroscopy and a Rutherford back-scattering method.

In the electrophotographic photosensitive member for positive charging, the photosensitive member surface layer also has a charge injection blocking function for blocking injection of positive holes, which are charged electric charges, into the photoconductive layer.

The photosensitive member surface layer may have a single-layer structure or a multiple-layer structure. In the case of the multiple-layer structure, as illustrated in FIG. 2, it is preferable that as first region 206-1, a second region 206-2, and a third region 206-3 should be arranged from the photoconductive layer side.

In the first region, the reflection of light generated at an interface between the photoconductive layer and the photosensitive member surface layer can be suppressed by changing the proportion of carbon atoms stepwise or continuously.

In the second region, in order to raise the transmittance of image exposure light, the ratio (C/(Si+C)) of the number of carbon atoms (C) to a sum (Si+C) of the number of silicon atoms (Si) and the number of carbon atoms (C) is preferably from 0.50 to 0.80.

The third region is a region that becomes an outermost surface. From the viewpoint of the durability, it is preferable that the film thickness of the third region should be 150 nm or more. In the third region, in order to improve the image characteristics and the durability, the above-described ratio [C/(Si+C)] is preferably 0.85 or more and is more preferably 0.95 or more.

In a surface region A that is a region near the surface from the surface of the photosensitive member surface layer to a depth 100 nm, the ratio [C/(Si+C)] of the number of carbon atoms (C) to a sum of the number of carbon atoms (C) and the number of silicon atoms (Si) is 0.85 or more. Preferably, the ratio [C/(Si+C)] described above is 0.95 or more.

The upper limit of the ratio [C/(Si+C)] described above is not particularly limited and, for example, is preferably 1.00. In other words, the ratio of the number of carbon atoms described above is preferably 0.85 to 1.00 and is more preferably 0.95 to 1.00.

By setting the value of [C/(Si+C)] described above in a region near the surface of the photosensitive member surface layer within the above-described range, the hardness of the photosensitive member surface layer is increased, and the wear resistance is improved.

The value of the above-described ratio [C/(Si+C)] can be controlled by the kind, the ratio, the supply amount, and the like of a raw material gas at the time of forming the photosensitive member surface layer using a method to be described below. For example, the value of the above-described ratio [C/(Si+C)] can be configured to be 0.85 or more by sufficiently increasing the supply amount of the gas comprising carbon with respect to the supply amount of the gas comprising silicon. The value of the above-described ratio [C/(Si+C)] at the surface region A can be measured using a method to be described below.

### Method of Manufacturing Electrophotographic Photosensitive Member

As the method of manufacturing the electrophotographic photosensitive member, any method may be used as long as it can form the layers satisfying the above-described requirements. More specifically, examples thereof include a plasma CVD method, a vacuum deposition method, a sputtering method, an ion plating method, and the like. Among them, the plasma CVD method is preferable from the viewpoint of the easiness of raw material supply and the like. Hereinafter, a manufacturing apparatus and a manufacturing method for an electrophotographic photosensitive member using the plasma CVD method are described.

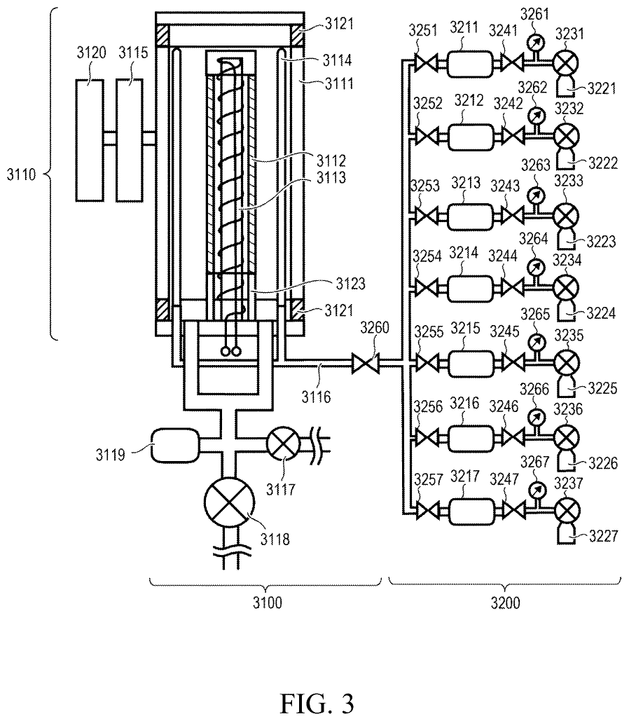

For example, an electrophotographic photosensitive member can be manufactured by forming the above-described respective layers as deposited films on a conductive substrate by using a deposition apparatus. FIG. 3 is a diagram schematically illustrating an example of a deposition apparatus according to the RF plasma CVD method using a high-frequency power supply that can be used to manufacture an electrophotographic photosensitive member.

When largely divided, this deposition apparatus is constituted by a deposition device 3100 having a reaction vessel 3110, a raw material gas supplying device 3200, and an exhaust device (not illustrated) for reducing the pressure of the inside of the reaction vessel 3110.

A substrate 3112, which is connected to the earth, a substrate heater 3113, and a raw material gas introduction pipe 3114 are provided inside the reaction vessel 3110 in the deposition device 3100. Furthermore, a high-frequency power supply 3120 is connected to a cathode electrode 3111 through a high-frequency matching box 3115.

The raw material gas supplying device 3200 is constituted by raw material gas cylinders 3221 to 3227, valves 3231 to 3237, pressure regulators 3261 to 3267, inflow valves 3241 to 3247, and outflow valves 3251 to 3257. Furthermore, mass flow controllers 3211 to 3217 are included therein. The raw material gas cylinders 3221 to 3227 filled with respective raw material gases are connected to the raw material gas introduction pipe 3114 inside the reaction vessel 3110 through an auxiliary valve 3260. Reference numeral 3116 denotes a gas piping, reference numeral 3117 denotes a leak valve, and reference numeral 3121 denotes an insulating material.

Next, a method of forming a deposited film using this apparatus is described.

First, the substrate 3112 that has been degreased and cleaned in advance is installed on the reaction vessel 3110 through a support stand 3123. Next, an exhaust apparatus (not illustrated) is operated to exhaust the inside of the reaction vessel 3110. When the pressure of the inside of the reaction vessel 3110 reaches a predetermined pressure, for example, that is 1 Pa or less while the display of a vacuum gauge 3119 is observed, power is supplied to the substrate heater 3113 to heat the substrate 3112, for example, to a predetermined temperature of 50 to 350° C. At this time, by supplying an inert gas such as Ar or He from the raw material gas supplying device 3200 to the reaction vessel 3110, heating can be performed in the atmosphere of the inert gas.

Next, gas used for forming a deposited film is supplied from the raw material gas supplying device 3200 to the reaction vessel 3110. In other words, the valves 3231 to 3237, the inflow valves 3241 to 3247, and the outflow valves 3251 to 3257 are opened as necessary to set flow rates to the mass flow controllers 3211 to 3217. After the flow rates of the respective mass flow controllers become stable, the main valve 3118 is operated to adjust the pressure of the inside of the reaction vessel 3110 to 20 to 100 Pa while the display of the vacuum gauge 3119 is observed. When a desired pressure is obtained, the high-frequency power is applied from the high-frequency power supply 3120 and, at the same time, the high-frequency matching box 3115 is operated to generate plasma discharge inside the reaction vessel 3110. Thereafter, the high-frequency electric power is quickly adjusted to 100 to 1000 W to form a deposited film.

When the formation of the predetermined deposited films is completed, the application of the high-frequency electric power is stopped, and the valves 3231 to 3237, the inflow valves 3241 to 3247, the outflow valves 3251 to 3257, and the auxiliary valve 3260 are closed to end the supply of the raw material gas. At the same time, the main valve 3118 is fully opened to exhaust the inside of the reaction vessel 3110 to a pressure of 1 Pa or less.

The deposited film can be formed using the method described above. When a plurality of deposited films are to be formed, the substrate on which the deposited films are formed is used as the substrate 3112, and the above-described procedure is repeated to form each layer again. A bonding region can also be formed by changing the flow rate, the pressure, and the like of the raw material gas, for example, in accordance with conditions for forming the photoconductive layer in a predetermined time.

After the formation of all the deposited films is completed, the main valve 3118 is closed, an inert gas is introduced into the inside of the reaction vessel 3110, and the pressure of the inside thereof is returned to the atmospheric pressure, and thereafter, the substrate 3112 is taken out.

In the formation of the pressure-resistant layer 202, for example, a silane-based gas such as silane (SiH₄), disilane (Si₂H₆), or the like can be appropriately used as a raw material gas for supplying silicon atoms.

In addition, as a raw material gas for supplying nitrogen atoms, for example, ammonia (NH₃), nitrogen (N₂), or the like can be appropriately used. Furthermore, as a raw material gas for supplying oxygen atoms in the case of containment of oxygen atoms, for example, oxygen (O₂), nitrogen monoxide (NO), and the like can be appropriately used in addition to the above-described raw material gases.

In addition, as a raw material gas for supplying hydrogen atoms, in addition to the above-described raw material gases, for example, hydrogen (H₂) can be appropriately used. Furthermore, in a case in which carbon atoms and the like are comprised in the pressure-resistant layer in order to improve adhesiveness for the conductive substrate, a gaseous material comprising the atoms to be comprised or a material that can be easily gasified may be appropriately used as the material.

In forming the charge injection blocking layer 203 and the upper injection blocking layer 205, as a raw material gas for supplying silicon atoms, as described above, a silane-based gas such as silane (SiH₄) or disilane (Si₂H₆) can be appropriately used. In addition, as a raw material gas for supplying Group 13 atoms, for example, diborane (B₂H₆) or the like can be appropriately used. As a raw material gas for supplying Group 15 atoms, for example, ammonia (NH₃), nitrogen (N₂), phosphine (PH3), arsine (AsH₃), or the like can be appropriately used.

Furthermore, as a raw material gas for supplying hydrogen atoms, for example, hydrogen (H₂) can be appropriately used in addition to the above-described raw material gases. In addition, in a case in which the charge injection blocking layer comprises carbon atoms, oxygen atoms, nitrogen atoms or the like in order to improve the adhesiveness for the pressure-resistant layer, a gaseous material comprising the respective atoms or a material that can be easily gasified may be appropriately used as the material. For example, nitrogen monoxide (NO), methane (CH₄), or the like can be appropriately used.

In forming the photoconductive layer, as a raw material gas for supplying silicon atoms, as described above, a silane-based gas such as silane (SiH₄), disilane (Si₂H₆), or the like can be appropriately used. In addition, as a raw material gas for supplying hydrogen atoms, in addition to the above-described silane-based gas, for example, hydrogen (H₂) can be appropriately used as well. Furthermore, atoms for controlling the conductivity of electrons (for example, Group 13 atoms or Group 15 atoms), carbon atoms, oxygen atoms, nitrogen atoms, or the like are comprised in the photoconductive layer, a gaseous material comprising respective atoms or a material that can be easily gasified may be appropriately used as the material.

In a case in which a-SiC or a-C is to be formed as the photosensitive member surface layer, as a raw material gas for supplying silicon atoms, as described above, a silane-based gas such silane (SiH₄), disilane (Si₂H₆), or the like can be appropriately used. In addition, as a raw material gas for supplying carbon atoms, for example, a gas such as methane (CH₄) or acetylene (C₂H₂) can be appropriately used. As a raw material gas for supplying hydrogen atoms, for example, hydrogen (H₂) can be appropriately used as well.

For example, in a case in which silane (SiH₄) is used as a raw material gas for supplying silicon atoms, and methane (CH₄) is used as a raw material gas for supplying carbon atoms, it is preferable that the supply amount of silane (SiH₄) should be 0.05 to 5 (ml/min), and the supply amount of methane (CH₄) should be 150 to 300 ml/min. By configuring the respective supply amounts to be in the ranges described above, the value of the above-described ratio [C/(Si+C)] in a region near the surface of the photosensitive member surface layer can be 0.85 or more.

The composition of each layer can be changed depending on the kind of the material gas and the like, and the smaller the amount of the gas comprising atoms that adjust the component ratio, the lower the component ratio in the layer. Examples of film formation parameters other than the kind of the raw material gas include substrate temperature, applied high-frequency electric power, addition of a diluent gas, a film formation pressure, and a film formation rate.

### Intermediate Transfer Belt

The image forming apparatus has a transfer means for transferring a toner image from the surface of an electrophotographic photosensitive member to a transfer member. The transfer member is an intermediate transfer belt that comprises a substrate layer, an elastic layer, and a transfer member surface layer. It can be checked that the transfer member comprises the substrate layer, the elastic layer, and the transfer member surface layer, for example, through cross-sectional observation of the transfer member.

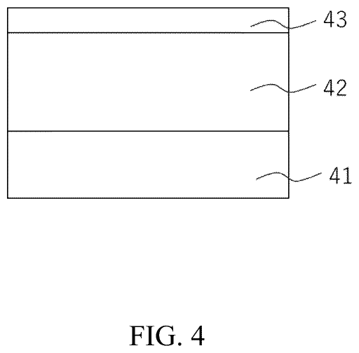

The transfer member comprised in the image forming apparatus, as illustrated in FIG. 4, is an intermediate transfer belt constituted by at least three layers including a substrate layer 41, an elastic layer 42 and a transfer member surface layer 43. However, the configuration is not limited to these three layers, and a primer layer for improving the adhesiveness and an intermediate layer for suppressing the bleed substance from the elastic layer 42 may be provided between the layers.

Each component of the intermediate transfer belt is described below. In the following description, the reference numerals are omitted.

### Substrate Layer

The substrate layer of the transfer member is described. As the substrate layer, for example, a cylindrical substrate of a seamless type in the form of a roll or a belt can be used.

Examples of the material that is appropriate for the substrate layer include resin materials such as polyester, polyimide, polyamide, polyamideimide, polyacetal, polyphenylene sulfide, polyvinylidene fluoride, vinylidene fluoride-hexafluoropropylene copolymer, ethylene-tetrafluoroethylene copolymer, polyhexafluoropropylene, ethylene-vinylidene fluoride copolymer, vinylidene fluoride-tetrafluoroethylene copolymer, and vinylidene fluoride-hexafluoropropylene-tetrafluoroethylene copolymer. It is preferable that the substrate layer should comprise polyvinylidene fluoride.

Conductivity may be given to the resin that is used for the substrate layer by adding a conductive compound such as metal powder, conductive oxide powder, conductive carbon, lithium salt, or an ionic liquid thereto. For example, from the viewpoint of obtaining excellent productivity and conductivity, it is preferable to use polyvinylidene fluoride to which polyalkylene glycol and a lithium salt have been added. As polyalkylene glycol, for example, ethylene oxide-propylene oxide copolymer or the like can be used. In addition, as the lithium salt, for example, lithium perchlorate or the like can be used. In addition, a combination of other exemplified resins with a conducting agent may be used.

The thickness of the substrate layer is preferably 10 to 500 μm and is more preferably 70 to 200 μm. Since the thickness of the substrate layer is 10 μm or more, the mechanical strength can be maintained. Furthermore, since the thickness of the substrate layer is 500 μm or less, the rigidity is not excessively increased, and softness that can be used as the intermediate transfer member can be maintained. By configuring the thickness of the substrate layer within the range described above, an intermediate transfer member having moderate flexibility and a sufficient mechanical strength can be obtained.

### Elastic Layer

Next, the elastic layer of the transfer member is described.

In order to follow the surface shapes of an electrophotographic photosensitive member and a transfer paper, the elastic layer needs an appropriate flexibility. As a material that is appropriate for the elastic layer, a material such as thermoplastic elastomer or rubber can be appropriately selected.

Examples of the thermoplastic elastomer include polyamide elastomer, polyester elastomer, polyurethane elastomer, polyolefin elastomer, polystyrene elastomer, diene elastomer, polyvinyl chloride elastomer, a mixture of a thermoplastic resin and rubber, and the like.

Examples of the rubber include styrene-butadiene rubber, butadiene rubber, isoprene rubber, EPDM, acrylonitrile-butadiene rubber, chloroprene rubber, butyl rubber, silicone rubber, fluororubber, urethane rubber, acrylic rubber, epichlorohydrin rubber, norbornene rubber, and the like.

Such thermoplastic elastomers and rubbers may be used alone, or two or more thereof may be mixed and used as necessary.

In order to improve adhesiveness for the transfer member surface layer comprising a urethane resin, materials having a urethane structure such as polyurethane elastomer and urethane rubber are preferable as the material of the elastic layer. It is preferable that the elastic layer should comprise thermoplastic polyurethane.

The thermoplastic elastomer or rubber used for the elastic layer preferably has a Shore A hardness of 80 degrees or less and more preferably has a Shore A hardness of 70 degrees or less. Since the Shore A hardness of the elastic layer is 80 degrees or less, transferability for an uneven paper can be maintained without degrading the followability.

The thickness of the elastic layer is preferably 80 to 600 μm, and is more preferably 200 to 500 μm.

By adding a conductive compound such as a metal powder, a conductive oxide powder, a conductive carbon, a lithium salt, an ionic liquid, or the like to the elastic layer, conductivity may be imparted thereto. For example, from the viewpoint of being able to obtain excellent productivity, it is preferable to use a polyurethane-based elastomer to which polyalkylene glycol and lithium salt have been added. As the polyalkylene glycol or lithium salt, for example, the above-described materials can be used. In addition, a combination of other exemplified resins with a conducting agent may be used.

In addition, the elastic layer may also comprise additives such as a filler, a crosslinking accelerator, a crosslinking retarder, a crosslinking co-agent, a scorch inhibitor, an antioxidant, a softener, a heat stabilizer, a flame retardant, a flame retardant aid, an ultraviolet absorber, and a rust inhibitor. The intermediate transfer belt is required to have frame retardancy for conduction in the transfer portion. Since it is difficult to secure required flame retardancy in various elastomers and rubbers, it is preferable to add a flame retardant thereto. Examples of the flame retardant include metal hydroxides such as magnesium hydroxide and aluminum hydroxide that use endothermic actions, a platinum compound and a phenol compound that inhibit thermal decomposition, an intumescent-based compound that has an oxygen blocking effect, and a phosphate ester condensation compound.

A method for manufacturing the substrate layer and the elastic layer is not particularly limited, and a known method can be used. For example, they can be manufactured by kneading materials for forming each layer to form pellets and molding the pellets by extrusion.

For example, the materials of the substrate layer are kneaded using a twin-screw kneader to form a pellet for the substrate layer. Similarly, the materials of the elastic layer are kneaded to form a pellet for the elastic layer. Subsequently, a single screw extruder is prepared for each of the pellet for the substrate layer and the pellet for the elastic layer, the two single screw extruders are connected to a cylindrical die for co-extrusion, and cylindrical extrusion is performed, whereby a two-layer belt constituted by the substrate layer and the elastic layer can be formed. By controlling a relative ratio between the take-up speed of a cylindrical draw-up device and the feeder speed of the pellet, the thicknesses of the substrate layer and the elastic layer can be respectively controlled.

In addition to the above-described method, a method in which the substrate layer is formed independently, and then the elastic layer is formed to be superimposed thereon may be used.

In order to improve the adhesiveness between the elastic layer and the transfer member surface layer, it is preferable to modify the surface of the elastic layer. The method for surface modification is not particularly limited, but for example, surface modification can be performed using UV irradiation. For example, it is preferable to modify the surface of the elastic layer by applying UV irradiation for 10 to 60 minutes in a space filled with nitrogen gas.

### Transfer Member Surface Layer

Next, the transfer member surface layer is described.

The transfer member surface layer needs to have excellent bending resistance and flexibility and thus preferably has a low surface free energy to improve the toner releasing property and has a low frictional force to improve the bending resistance. As an example of a material having excellent bending resistance and flexibility, there is a urethane resin, but there is a problem that it has high surface free energy and a high frictional force. For this reason, it is important to mix a resin for reducing the surface free energy and the frictional force with the urethane resin, but there are cases in which the transferability is lowered due to electric charges generated by friction with the surface of the electrophotographic photosensitive member depending on the selection of the material.

The inventors and the like of the present disclosure have found that the generation of charges according to triboelectric charging can be suppressed by configuring the transfer member surface layer to have the following configuration. In other words, the transfer member surface layer comprises a first resin and a second resin. This first resin comprises at least one selected from the group consisting of a silicone-acrylic polymer having a silicone segment and an acrylic polymer segment; and a silicone-vinyl acetate polymer having a silicone segment and a vinyl acetate polymer segment. This second resin comprises a urethane resin.

By configuring the transfer member surface layer to comprise the above-described first resin, a triboelectric series difference from the electrophotographic photosensitive member surface on which many carbon atoms are present is reduced. For this reason, the generation of charges according to triboelectric charging can be suppressed, and an image forming apparatus of which the deterioration of transferability at the time of repeated use under a low-humidity environment is suppressed can be provided. In addition, since the transfer member surface layer comprises the above-described second resin, bending resistance and flexibility can be improved. As a result, the wear resistance, the media follow-up property, the toner releasing property, and the like can be maintained in a range that does not cause any problem in practical use.

### First Resin

The first resin comprises at least one selected from the group consisting of a silicone-acrylic polymer having a silicone segment and an acrylic polymer segment and a silicone-vinyl acetate polymer having a silicone segment and a vinyl acetate polymer segment. It is preferable that the first resin should comprise the silicone-acrylic polymer described above or the silicone-vinyl acetate polymer described above. The first resin is more preferably the above-described silicone-acrylic polymer or the above-described silicone-vinyl acetate polymer.

It is preferable that the first resin should comprise a silicone-acrylic polymer having a silicone segment and an acrylic polymer segment. It is more preferable that the first resin should be a silicone-acrylic polymer having a silicone segment and an acrylic polymer segment.

Since the first resin comprises a silicone-acrylic polymer, a triboelectric series difference from the electrophotographic photosensitive member surface is further reduced. For this reason, the generation of charges according to triboelectric charging can be more easily suppressed, and the deterioration of transferability at the time of repeated use under a low-humidity environment can be more easily suppressed.

A silicone-acrylic polymer has a silicone segment and an acrylic polymer segment and exhibits properties that combine the properties of both the silicone resin and acrylic resin.

In the present disclosure, a silicone segment refers to a segment comprising an organopolysiloxane in which an organic functional group is bonded to a siloxane bond. Examples of the organic functional group include an alkyl group, a phenyl group, a hydroxyl group, an amino group, and the like.

In the present disclosure, the acrylic polymer segment represents a segment that comprises a polymer using a (meth)acrylic monomer such as a (meth)acrylic acid and a (meth)acrylic acid ester. Examples of the (meth)acrylic monomer include acrylic acid, methacrylic acid, methyl acrylate, methyl methacrylate, and the like. In addition, the (meth)acryl represents acryl, methacrylic, or a generic term thereof.

Examples of the silicone-acrylic polymer include polymers such as a random polymer, an alternating polymer, a block polymer, and a graft polymer according to the arrangement of a silicone segment and an acrylic polymer segment. Among these, the graft polymer in which the properties of both the silicone resin and the acrylic resin are easily exhibited is preferable. Furthermore, a graft polymer having an acrylic polymer segment as a main chain and a silicone segment as a side chain is more preferable.

In other words, the silicone-acrylic polymer is preferably a graft polymer of a silicone segment and acrylic polymer segment. Furthermore, the silicone-acrylic polymer is more preferably a graft polymer having an acrylic polymer segment as a main chain and a silicone segment as a side chain. In this case, since the triboelectric series difference between the electrophotographic photosensitive member surface and the intermediate transfer belt surface is further reduced, the generation of charges according to triboelectric charging can be suppressed, and the deterioration of the transferability can be further suppressed.

A silicone-vinyl acetate polymer has a silicone segment and a vinyl acetate polymer segment and exhibits characteristics that combine the properties of both the silicone resin and the vinyl acetate resin. Since the first resin comprises a silicone-vinyl acetate polymer, the triboelectric series difference from the electrophotographic photosensitive member surface is further reduced. For this reason, the generation of charges according to triboelectric charging can be more easily suppressed, and the deterioration of transferability at the time of repeated use under a low-humidity environment can be more easily suppressed.

In the present disclosure, a vinyl acetate polymer segment represents a segment that comprises polyvinyl acetate obtained by polymerizing vinyl acetate.

Examples of the silicone-vinyl acetate polymer include polymers such as a random polymer, an alternating polymer, a block polymer, and a graft polymer according to the arrangement of a silicone segment and a vinyl acetate polymer segment. Among these, a graft polymer in which the properties of both a silicone resin and a vinyl acetate resin can be easily exhibited is preferable. In addition, a graft polymer having a silicone segment as a main chain and a vinyl acetate polymer segment as a side chain is more preferable.

In other words, it is preferable that the silicone-vinyl acetate polymer should be a graft polymer of a silicone segment and a vinyl acetate polymer. In addition, it is more preferable that the silicone-vinyl acetate polymer should be a graft polymer having a silicone segment as a main chain and a vinyl acetate polymer segment as a side chain. Since the above-described graft polymer has a flexible silicone segment as a main chain, by configuring the first resin to comprise the above-described graft polymer, the flexibility of the transfer member surface layer is improved, and transferability for uneven paper is improved.

### Second Resin

The second resin comprises a urethane resin. Since the second resin comprises a urethane resin, the media follow-up property can be improved.

By configuring the first resin to comprise the silicone-acrylic polymer or the silicone-vinyl acetate polymer and the second resin to comprise a urethane resin, a transfer member that is excellent in the bending resistance and the flexibility can be obtained. As a result, the abrasion resistance, the media follow-up property, the toner release property, and the like of the transfer member can be improved.

The urethane resin is a polymer having a urethane bond and is generated in accordance with a reaction between a polyisocyanate having a plurality of isocyanate groups and a polyol having a plurality of hydroxy groups.

Examples of the polyisocyanate include an aliphatic isocyanate, an aromatic isocyanate, and derivatives thereof. Examples of the aliphatic isocyanate include hexamethylene diisocyanate (HDI) and the like. Examples of the aromatic isocyanate include xylylene diisocyanate (XDI) diphenylmethane diisocyanate (MDI), tolylene diisocyanate (TDI), and the like. The aliphatic isocyanates suppress yellowing and thus is preferably used.

Examples of the polyol include a polyether polyol, a polyester polyol, a polycarbonate polyol, and the like. The polycarbonate polyol has excellent hydrolysis resistance and wear resistance and thus is preferably used.

It is preferable that the second resin should be a carbonate-based urethane resin that is a reaction product of an aliphatic isocyanate and a polycarbonate polyol. In a case in which the second resin is a carbonate urethane resin, a transfer member having excellent wear resistance can be obtained.

The content ratio of the first resin in the transfer member surface layer is commonly 10 to 90% by mass with respect to a total mass of the first resin and the second resin. The content ratio described above is preferably 20 to 80% by mass, is more preferably 20 to 70% by mass, and is still more preferably 30 to 50% by mass. In this case, generation of charges according to triboelectric charging between the electrophotographic photosensitive member and the intermediate transfer belt can be more easily suppressed, and deterioration of the transferability can be more suppressed.

The containment of the first resin and the second resin in the transfer member surface layer can be checked, for example, by time-of-flight secondary ion mass spectrometry (TOF-SIMS) or matrix-assisted laser desorption ionization time-of-flight mass spectrometry (MALDI-TOFMS).

More specifically, by detecting mass spectra derived from the first resin and the second resin using analysis described above, it can be checked that the transfer member surface layer comprises the first resin and the second resin, and the structures of the first resin and the second resin can be identified.

### Method of Forming Transfer Member Surface Layer

The method of forming the transfer member surface layer is not particularly limited and, for example, preferably includes the following processes.
(1) A mixing process of preparing a surface layer coating solution by mixing an emulsion in which the first resin is dispersed in water and an emulsion in which the second resin is dispersed in water
(2) A coating process of coating the elastic layer with the acquired surface layer coating solution
(3) A drying process of form the transfer member surface layer by heating and drying the applied surface layer coating solution

In the mixing process, for example, an emulsion in which the first resin is dispersed in water and an emulsion in which the second resin is dispersed in water are mixed, the concentration is adjusted with a solvent such as water, and the mixture is stirred for 3 minutes or more, whereby a surface layer coating solution can be prepared.

The concentration of the surface layer coating solution is preferably adjusted such that the solid content ratio is 10 to 30% by mass. The content of the first resin in the surface layer coating solution is more preferably 20 to 80% by mass, even more preferably 20 to 70% by mass, and still more preferably 30 to 50% by mass.

In the coating process, for example, a surface layer coating solution can be applied onto the elastic layer using bar coating, spray coating, dip coating, or the like. From the viewpoint of mass productivity, spray coating is preferable.

In the drying process, the transfer member surface layer can be formed, for example, by heating by means such as a heating furnace or a blasting dryer to volatilize the solvent of the applied surface layer coating solution and cure the coating film. The heating temperature is preferably 60 to 150° C. and is more preferably 110 to 130° C. When the heating temperature is too low, there is a problem in the film formation characteristics, and when the heating temperature is too high, there is a problem in the wear resistance. Although the heating time can be adjusted depending on the heating temperature, for example, in the case of heating at 60 to 150° C., it is preferable to heat for 5 to 60 minutes.

The thickness of the transfer member surface layer is preferably 0.5 to 8.0 um and is more preferably 1.0 to 5.0 μm. When the thickness of the transfer member surface layer is too thin, there is a problem in the abrasion resistance, and when the transfer member surface layer is too thick, the flexibility is impaired, and the transferability for uneven paper is impaired. By configuring the thickness of the transfer member surface layer to be in the above-described range, the transfer member having excellent wear resistance and transferability for uneven paper can be obtained. The thickness of the transfer member surface layer can be controlled using the coating amount of the surface layer coating solution and the like in the coating process.

It is preferable that the outer surface of the transfer member surface layer should be smooth for the purpose of suppressing reduction of the transferability due to abnormal discharge. The surface roughness RzJIS of the outer surface is preferably less than 0.3 μm and is more preferably less than 0.1 μm. The surface roughness RzJIS is ten-point average roughness defined in JIS B0601:1994.

In a region having a start point that is the outer surface of the transfer member surface layer and an end point that is a position of 200 nm in the thickness direction of the transfer member surface layer from the outer surface, when the proportion of silicon atoms with respect to a sum of carbon atoms, nitrogen atoms, oxygen atoms, and the silicon atoms is measured using depth analysis of the X-ray photoelectron spectroscopy, the proportion of the silicon atoms is preferably 0.1 to 45.0 atomic %, is more preferably 0.2 to 40.0 atomic %, and is even more preferably 0.3 to 40.0 atomic %. In this case, since the triboelectric series difference between the surface of the electrophotographic photosensitive member and the surface of the intermediate transfer belt is further reduced, and thus the generation of charges due to triboelectric charging can be further suppressed, and the deterioration of the transferability can be further suppressed. In particular, the reduction of the transferability in the initial period of use can be further suppressed.

In addition, on the outer surface of the transfer member surface layer, when a proportion of silicon atoms with respect to a sum of carbon atoms, nitrogen atoms, oxygen atoms, and the silicon atoms is measured using X-ray photoelectron spectroscopy, the proportion of the silicon atoms is preferably 10.0 to 45.0 atomic %, is more preferably 15.0 to 40.0 atomic %, and is even more preferably 20.0 to 30.0 atomic %. By configuring the proportion of silicon atoms on the outer surface to be in the above-described range, the deterioration of the transferability, particularly in the initial period of use can be further suppressed.

In the outer surface of the transfer member surface layer and a region from the outer surface to a position of 200 nm in the thickness direction of the transfer member surface layer, the proportion of silicon atoms can be controlled using the content ratio of the first resin to a total mass of the first resin and the second resin and the heating temperature in the drying process performed at the time of forming the surface layer.

For example, in a case in which the heating temperature in the drying process performed at the time of forming the surface layer is constant, when the content ratio of the first resin to the total mass of the first resin and the second resin is low, the proportion of silicon atoms in the region from the outer surface to the position of 200 nm in the thickness direction of the transfer member surface layer becomes small. On the other hand, when the above-described content ratio of the first resin is high, the proportion of silicon atoms in that region becomes large.

On the other hand, in a case in which the content ratio of the first resin to the total mass of the first resin and the second resin is constant, when the heating temperature in the drying process performed at the time of forming the transfer member surface layer is low, the proportion of silicon atoms in the region from the outer surface to the position of 200 nm in the thickness direction of the transfer member surface layer becomes high, and the proportion of silicon atoms of the outer surface becomes low. When the heating temperature in the drying process is high, the proportion of silicon atoms in the region from the outer surface to the position of 200 nm in the thickness direction of the transfer member surface layer is low, and the proportion of silicon atoms in the outer surface is high.

### Measurement of Silicon Atom Proportion Using X-ray Photoelectron Spectroscopy (XPS) Method

The proportion of silicon atoms in the transfer member surface layer can be measured using X-ray photoelectron spectroscopy (XPS) as below.

The transfer member surface layer is cut into the size of a vertical 5 mm and a horizontal 5 mm, and the outer surface is attached to a sample base to be a front side (analysis surface side) using a carbon tape, and depth-direction analysis of the XPS is performed using a gas cluster ion beam (GCIB). The depth-direction analysis is performed in a region having a start point that is the outer surface of the transfer member surface layer and an end point that is a position of 200 nm in the thickness direction of the transfer member surface layer from the outer surface. The proportion of silicon atoms at the above-described start point is defined as the proportion of silicon atoms in the outer surface.

From a detected peak intensity, the proportion of silicon atoms to a sum of carbon atoms, nitrogen atoms, oxygen atoms, and silicon atoms can be measured.

For example, although the measurement can be performed using the following XPS apparatus and measurement conditions, the present disclosure is not limited thereto.
Apparatus used: PHI5000 VersaProbeII manufactured by ULVAC-PHI
Radiation ray: Al-Kα ray
Beam diameter: 100μ
Output: 25 W 15 kV
Photoelectronic uptake angle: 45°
PassEnergy: 58.70 eV
Step size: 0.125 eV
XPS Peak: Si2p, N1s, C1s, O1s
Measurement range: 300 μm×200 μm
Gun Type: GCIB
Sputter setting: 10 kV
Time: 10 min
Interval: 30 sec

In cross-section observation of the transfer member surface layer, when the thickness of the transfer member surface layer is denoted by X, in a region having a start point that is a position of 0.2X from the outer surface of the transfer member surface layer and an end point that is a position of 0.8X from the outer surface, it is preferable that a domain-matrix structure in which domains are dispersed in a matrix should be observed. In addition, it is preferable that this matrix should comprise the second resin, and the domain should comprise the first resin. In this case, the deterioration of the transferability particularly at the time of repeated use can be further suppressed.

For example, by controlling the baking temperature at the time of forming the transfer member surface layer to be 60 to 170° C., a configuration having the domain-matrix structure in the region described above can be employed.

By performing elemental analysis of the cross-section of the transfer member surface layer using a method such as energy dispersive X-ray analysis (EDX) and detecting silicon atoms in the domain, it can be checked that the first resin is comprised in the domain. In addition, by analyzing the cross-section of the transfer member surface layer using a method such as TOF-SIMS or MALDI-TOFMS and detecting a mass spectrum derived from the first resin in the domain and a mass spectrum derived from the second resin in the matrix, it can be checked that the first resin is comprised in the domain, and the second resin is comprised in the matrix.

### Cross-section Observation of Transfer Member Surface Layer

The cross-section of the transfer member surface layer can be observed using the following method. The intermediate transfer belt is cut out into the size of a vertical 10 mm and a horizontal 5 mm, and the cross-section portion is smoothed by ion milling or the like. By observing the transfer member surface layer at the magnification of 10000 using a scanning electron microscope (SEM), the cross section of the transfer member surface layer can be checked.

More specifically, the thickness X of the transfer member surface layer is measured through cross-section observation using SEM, and a region having a start point that is a position corresponding to 0.2X from the outer surface of the transfer member surface layer and an end point that is a position corresponding to 0.8X from the outer surface is specified. By visually observing the region described above, it can be checked that a domain-matrix structure is present inside the region.

By performing elemental analysis of the cross-section of the transfer member surface layer using a method such as energy dispersive X-ray analysis (EDX) and detecting silicon atoms in the domain, it can be checked that the first resin is comprised in the domain. In addition, by analyzing the cross-section of the transfer member surface layer using a method such as TOF-SIMS or MALDI-TOFMS and detecting a mass spectrum derived from the first resin in the domain and a mass spectrum derived from the second resin in the matrix, it can be checked that the first resin is comprised in the domain, and the second resin is comprised in the matrix.

### EXAMPLES

The present disclosure is more particularly described below using examples and comparative examples. Insofar as the essential features of the present disclosure are not exceeded, the present disclosure is in no way limited by the following examples. In the following text of the examples, “parts” is on a mass basis unless specifically indicated otherwise.

### Manufacturing Examples of Electrophotographic Photosensitive Members 1 and 2

An aluminum alloy tube (outer diameter: 84 mm, length: 370 mm) was prepared as the cylindrical conductive substrate.

A mirror treatment and a wet blasting treatment were performed for the outer peripheral surface of the prepared conductive substrate, and the treated conductive substrate was washed.

First, as the mirror treatment of the surface of the conductive substrate, in a state in which the conductive substrate was held at both ends and rotated at a high speed at 1500 to 8000 rpm, a diamond bite was pressed against the substrate, and the substrate was burnishing-processed at a feed rate of 0.08/se to 0.5 mm/sec. In other words, by pressing the finished surface of a diamond cutting tool having a depth in the direction of rotation of the work against the surface of the conductive substrate, a smooth finished surface was obtained.

After the mirror finishing, the conductive substrate was degreased and cleaned.

Next, as wet blasting, high-hardness abrasive such as alumina, and water were stirred, mixed with compressed air and accelerated, and projected onto the mirror-finished surface of the conductive substrate for roughening.

After the wet blasting, residues remaining on the surface were removed by washing to prepare a conductive substrate.

For the conductive substrate prepared in this way, respective layers were formed on the surface of the conductive substrate to have the layer configuration illustrated in FIG. 2 with film formation conditions represented in Table 1 using a deposition apparatus illustrated in FIG. 3, whereby an electrophotographic photosensitive member 1 that is an a-Si photosensitive member was produced. The photosensitive member surface layer was configured as a single layer.

An electrophotographic photosensitive member 2 was produced using a method similar to that of the electrophotographic photosensitive member 1 described above except for changes in the film formation conditions of the photosensitive member surface layer.

TABLE 1

| | | | Charge | | Upper | Surface layer | |
|---|---|---|---|---|---|---|---|
| | | Pressure- | injection | | injection | Electrophotographic | Electrophotographic |
| | | resistant | blocking | Photoconductive | blocking | photosensitive | photosensitive |
| Film formation conditions | | layer | layer | layer | layer | member 1 | member 2 |
| Raw | SiH₄ | 290 | 350 | 400 | 250 | 0.1 | 4 |
| material | (ml/min(normal)) | | | | | | |
| gas | H₂ | 750 | 750 | 2000 | — | 110 | 110 |
| supply | (ml/min(normal)) | | | | | | |
| amount | B₂H₆ | — | — | — | 150 | — | — |
| | (ppm for SiH₄) | | | | | | |
| | NO | 20 | 10 | — | — | — | — |
| | (ml/min(normal)) | | | | | | |
| | NH₃ | 60 | — | — | — | — | — |
| | (ml/min(normal)) | | | | | | |
| | CH₄ | — | 700 | — | 250 | 290 | 200 |
| | (ml/min(normal)) | | | | | | |

| | | | | | | |
|---|---|---|---|---|---|---|
| Internal pressure (Pa) | 40 | 40 | 80 | 60 | 80 | 80 |
| Power (W) | 400 | 400 | 800 | 200 | 400 | 400 |
| Substrate temperature (° C.) | 260 | 260 | 260 | 200 | 260 | 260 |
| Film thickness (μm) | 5.5 | 3.5 | 20 | 0.2 | 0.2 | 0.2 |

In the table, an internal pressure (Pa) represents the internal pressure of the reaction vessel at the time of forming each layer. The power (W) represents the wattage of the high-frequency power applied when each layer was formed.

For the electrophotographic photosensitive members 1 and 2 obtained as described above, a ratio (C/(Si+C)) of the number of carbon atoms to a sum of the number of the carbon atoms and the number of the silicon atoms in a near-surface region (surface region A) from the surface of the electrophotographic photosensitive member to a depth of 100 nm was acquired using the following method.

### Measurement of (C/Si+C)

The ratio (C/(Si+C)) of the number of carbon atoms to a sum of the number of carbon atoms and the number of silicon atoms in a near-surface region (surface region A) from the surface of the electrophotographic photosensitive member to a depth 100 nm was acquired using the following method.

An electrophotographic photosensitive member in which a pressure-resistant layer, a charge injection blocking layer, a photo-conductive layer, an upper injection blocking layer, and a surface layer represented in Table 1 were formed was produced, and the central portion in the longitudinal direction of the electrophotographic photosensitive member was cut into 15 mm squares, whereby samples for measurement were prepared.

The number of silicon atoms and carbon atoms in the surface layer in the measurement region of RBS (Rutherford back-scattering method) (AN-2500: Back-scattering analyzer, manufactured by Nissin High Voltage Co., Ltd.) was measured from the measurement sample described above using the RBS. In addition, by acquiring the depth information as well, the ratio (C/(Si+C)) of the number of carbon atoms to a sum of the number of the carbon atoms and the number of silicon atoms in a near-surface region (surface region A) from the surface of the electrophotographic photosensitive member to the depth 100 nm was acquired.

The measurement results are represented in Table 2.

TABLE 2

| | C/(Si + C) |
|---|---|
| Electrophotographic photosensitive member 1 | 0.99 |
| Electrophotographic photosensitive member 2 | 0.85 |

### Manufacturing Example of Intermediate Transfer Belt 1

### Production of Pellet for Substrate Layer

The following materials were kneaded using a twin-screw kneader (trade name: PCM30, manufactured by Ikegai Co., Ltd.) to obtain such pellets.
Polyvinylidene fluoride (trade name: Solef9007, manufactured by Solvay Specialty Polymers Japan Co., Ltd.) 95 parts by mass
Lithium perchlorate (Anhydrous 98%, manufactured by Kanto Chemical Co., Ltd.) 0.7 parts by mass
Ethylene oxide-propylene oxide copolymer (Pluronic F-127, manufactured by Merck Co., Ltd.) 4.3 parts by mass

### Production of Pellets for Elastic Layer

The following materials were kneaded using a twin-screw kneader (trade name: PCM30, manufactured by Ikegai Co., Ltd.) to obtain such pellets.
Thermoplastic polyurethane (trade name: Elastran 1175A 10W, manufactured by BASF Japan Co., Ltd) 98 parts by mass.
Lithium perchlorate (anhydrous 98%, manufactured by Kanto Chemical Co., Ltd.) 0.2 parts by mass
Ethylene oxide-propylene oxide copolymer (Pluronic F-127, manufactured by Merck Co., Ltd.) 1.8 parts by mass

### Formation of Two-layer Belt Constituted by Substrate Layer and Elastic Layer

The pellet for the substrate layer and the pellet for the elastic layer were used to produce a belt having a two-layer structure through co-extrusion.

More specifically, a single screw extruder (trade name: GT40, manufactured by Plastic Engineering Laboratories, Ltd.) was prepared for each of the pellet for the substrate layer and the pellet for the elastic layer. Subsequently, two single screw extruders were connected to a cylindrical die for co-extrusion, and cylindrical extrusion is performed, whereby a two-layer belt was acquired. The molten resin ejected from the single screw extruder was composed of polyvinylidene fluoride in the inner layer and thermoplastic polyurethane in the outer layer on the cylindrical die for co-extrusion.

When the cylindrical extrusion is performed, a target film thickness was set for each layer thickness using a relative ratio between a take-up speed of a cylindrical drawing machine and a feeder speed of the pellet for the substrate layer and the pellet for the elastic layer. The feeder speed was adjusted such that the thickness of the substrate layer, which is the inner layer, was 120 μm, and the thickness of the elastic layer was 270 μm.

In the process of being withdrawn, the two-layer belt was cooled and solidified by being in contact with a cooled mandrel provided between the cylindrical die and the cylindrical drawn-up machine. The solidified resin was cut into a width 400 mm using a cylindrical cutting machine installed in a lower part of the cylinder take-up machine.

The hardness of the elastic layer of the acquired two-layer belt was measured to be 75 degrees by a JIS A rubber hardness meter.

### Surface Modification of Elastic Layer

In order to improve the adhesiveness between the elastic layer and the transfer member surface layer, the surface modification of the elastic layer was performed. For the surface modification, an excimer lamp (manufactured by M.D. COM, Ltd.) emitting a single wavelength of 172 nm as an excimer UV irradiation unit was used. The two-layer belt constituted by the substrate layer and the elastic layer was fitted onto a cylindrical core, and irradiation was performed for 30 minutes in a space filled with nitrogen gas while rotating the core existing at a distance of about 1 mm from the surface of the excimer lamp at the rotation speed of 5 rpm.

### Method of Forming Transfer Member Surface Layer

The materials for the transfer member surface layer were as represented below, the concentration thereof was adjusted using water such that the solid content ratio was 20% by mass, and the mixture was stirred and mixed for 10 minutes to obtain a resin liquid for coating the transfer member surface layer.

First Resin: silicone-acrylic graft polymer resin emulsion having an acrylic polymer segment as a main chain and a silicone segment as a side chain (trade name: SIMAC US-450 (30% by mass solids), manufactured by Toa synthesis Co., Ltd.) 30 parts by mass

Second Resin: carbonate-based urethane resin emulsion (trade name: Super Flex SF460 (38% by mass solids), manufactured by Dai-ichi Kogyo Seiyaku Co., Ltd.) 55 parts by mass

Subsequently, the two-layer belt constituted by the substrate layer and the elastic layer was fitted into a cylindrical core, and a coating resin liquid for the transfer member surface layer was spray-coated on the surface of the elastic layer such that the film thickness of the transfer member surface layer after drying became 3 μm. Thereafter, the transfer member was placed in a heating furnace in the state of being attached to the core and was heated at 120° C. for 10 minutes to cure the coating film, whereby an intermediate transfer belt in which the transfer member surface layer was formed on the elastic layer was produced. The produced intermediate transfer belt was cut to obtain an intermediate transfer belt 1 having a width of 360 mm and a peripheral length of 2236 mm.

The content ratio of the first resin in the surface layer of the intermediate transfer belt 1 was 30% by mass with respect to the total mass of the first resin and the second resin.

### Measurement of Silicon Atom Proportion According to XPS Method

The intermediate transfer belt 1 was cut into the size of a vertical 5 mm and a horizontal 5 mm and adhered to a sample base using a carbon tape in a state in which the outer surface of the transfer member surface layer is on the front side. A region having a start point that is the outer surface of the intermediate transfer belt 1 and an end point that is a position of 200 nm in the thickness direction of the transfer member surface layer from the outer surface was analyzed using an XPS apparatus. The analysis conditions were as described above.

The proportion of silicon atoms in the outer surface of the transfer member surface layer of the intermediate transfer belt 1 was 23.0 atomic %. The proportion of silicon atoms in a region having a start point that is the outer surface and an end point that is the position of 200 nm in the thickness direction of the transfer member surface layer from the outer surface was constantly in the range of 0.3 to 40.0 atomic %.

### Cross-section Observation of Transfer Member Surface Layer

The intermediate transfer belt 1 was cut into the size of a vertical 10 mm and a horizontal 5 mm, and the cross-section portion was smoothed by ion milling. The cross-section of the transfer member surface layer was checked at a magnification of 10000 using a scanning electron microscope (SEM).

The thickness X of the transfer member surface layer was 3.0 μm. In a region having a start point that is a position of 0.6 μm corresponding to 0.2X from the outer surface of the transfer member surface layer and an end point that is a position of 2.4 μm corresponding to 0.8X from the outer surface, a domain-matrix structure in which domains are disposed in a matrix wax observed. Thereafter, elemental analysis was performed using energy dispersive X-ray analysis (EDX), and silicon atoms were detected in the domain, whereby it was checked that the domain comprised a silicone-acrylic polymer.

### Manufacturing Example of Intermediate Transfer Belt 2

An intermediate transfer belt 2 was obtained in the same manner as the manufacturing example of the intermediate transfer belt 1 except that the materials of the transfer member surface layer were as follows.
First Resin: Acrylic-silicone graft polymer resin emulsion having a silicone segment as a main chain and an acrylic polymer segment as a side chain (trade name: Sharine FE-230N (30% by mass solids), manufactured by Nisshin Chemical Industry Co., Ltd.) 30 parts by mass
Second Resin: carbonate-based urethane resin emulsion (trade name: Super Flex SF460 (38% by mass solids), manufactured by Dai-ichi Kogyo Seiyaku Co., Ltd.) 55 parts by mass

The proportion of silicon atoms and results of cross-section observation of the transfer member surface layer according to the XPS method are represented in Table 3.

### Manufacturing Example of Intermediate Transfer Belt 3 to 14

Intermediate transfer belts 3 to 14 were obtained in the same manner as in the manufacturing example of the intermediate transfer belt 1 except that the content ratio of the first resin and the baking temperature of the transfer member surface layer were set as represented in Table 3.

The proportion of silicon atoms and results of cross-section observation of the transfer member surface layer according to the XPS method are represented in Table 3.

### Manufacturing Example of Intermediate Transfer Belt 15

An intermediate transfer belt 15 was obtained in the same manner as in the manufacturing example of the intermediate transfer belt 1, except that the materials of the transfer member surface layer were set as described below, and the content ratio of the first resin and the baking temperature of the transfer member surface layer were set as represented in Table 3.
First Resin: Vinyl acetate-silicone graft polymer resin emulsion having a silicone segment as a main chain and a vinyl acetate polymer segment as a side chain (trade name: Sharine 1827 (30% by mass solids), manufactured by Nisshin Chemical
Industry Co., Ltd.) 30 parts by mass
Second Resin: carbonate-based urethane resin emulsion (trade name: Super Flex SF460 (38% by mass solids), manufactured by Dai-ichi Kogyo Seiyaku Co., Ltd.) 55 parts by mass

### Manufacturing Example of Intermediate Transfer Belt 16

An intermediate transfer belt 16 was obtained in the same manner as in the manufacturing example of the intermediate transfer belt 1 except that the materials of the transfer member surface layer were used as described below.
First Resin: Fluorine-based resin emulsion (trade name: Asahi Gard AG-E 550D (30% by mass solids), manufactured by Meisei Chemical Industry Co., Ltd.) 30 parts by mass
Second Resin: carbonate-based urethane resin emulsion (trade name: Super Flex SF460 (38% by mass solids), manufactured by Dai-ichi Kogyo Seiyaku Co., Ltd.) 55 parts by mass

### Manufacturing Example of Intermediate Transfer Belt 17

An intermediate transfer belt 17 was obtained in the same manner as in the manufacturing example of the intermediate transfer belt 1 except that the materials of the transfer member surface layer were used as described below.
First Resin: None
Second Resin: carbonate-based urethane resin emulsion (trade name: Super Flex SF460 (38% by mass solids), manufactured by Dai-ichi Kogyo Seiyaku Co., Ltd.) 100 parts by mass

TABLE 3

| | | | Baking | | | | |
|---|---|---|---|---|---|---|---|
| | | | temperature | | Silicon atom | Silicon atom | |
| Intermediate | | | of surface | Content ratio | proportion | proportion | |
| transfer belt | | | layer | of first resin | (200 nm) | (outer surface) | 0.2X-0.8X |
| No. | First resin | Second resin | (° C.) | (% by mass) | (atomic %) | (atomic %) | Structure |
| 1 | Silicone-acrylic graft | Carbonate-based | 120 | 30 | 0.3~40.0 | 23.0 | Domain- |
| | polymer resin | urethane resin | | | | | matrix |
| 2 | Acrylic-silicone graft | Carbonate-based | 120 | 30 | 0.3~40.0 | 20.2 | Domain- |
| | polymer resin | urethane resin | | | | | matrix |
| 3 | Silicone-acrylic graft | Carbonate-based | 150 | 30 | 0.2 | 28.1 | Domain- |
| | polymer resin | urethane resin | | | | | matrix |
| 4 | Silicone-acrylic graft | Carbonate-based | 145 | 30 | 0.3 | 26.8 | Domain- |
| | polymer resin | urethane resin | | | | | matrix |
| 5 | Silicone-acrylic graft | Carbonate-based | 145 | 70 | 40.0 | 39.7 | Domain- |
| | polymer resin | urethane resin | | | | | matrix |
| 6 | Silicone-acrylic graft | Carbonate-based | 150 | 70 | 41.0 | 41.0 | Domain- |
| | polymer resin | urethane resin | | | | | matrix |
| 7 | Silicone-acrylic graft | Carbonate-based | 60 | 20 | 0.3~40.0 | 10.2 | Domain- |
| | polymer resin | urethane resin | | | | | matrix |
| 8 | Silicone-acrylic graft | Carbonate-based | 110 | 20 | 0.3~40.0 | 15.1 | Domain- |
| | polymer resin | urethane resin | | | | | matrix |
| 9 | Silicone-acrylic graft | Carbonate-based | 120 | 15 | 0.3~40.0 | 18.0 | Domain- |
| | polymer resin | urethane resin | | | | | matrix |
| 10 | Silicone-acrylic graft | Carbonate-based | 120 | 20 | 0.3~40.0 | 20.1 | Domain- |
| | polymer resin | urethane resin | | | | | matrix |
| 11 | Silicone-acrylic graft | Carbonate-based | 120 | 50 | 0.3~40.0 | 28.0 | Domain- |
| | polymer resin | urethane resin | | | | | matrix |
| 12 | Silicone-acrylic graft | Carbonate-based | 120 | 80 | 0.3~40.0 | 37.0 | Domain- |
| | polymer resin | urethane resin | | | | | matrix |
| 13 | Silicone-acrylic graft | Carbonate-based | 120 | 85 | 0.3~40.0 | 39.8 | Domain- |
| | polymer resin | urethane resin | | | | | matrix |
| 14 | Silicone-acrylic graft | Carbonate-based | 180 | 30 | 0.1 | 35.3 | — |
| | polymer resin | urethane resin | | | | | |
| 15 | Vinyl acetate-silicone | Carbonate-based | 120 | 30 | 0.3~40.0 | 20.0 | Domain- |
| | graft polymer resin | urethane resin | | | | | matrix |
| 16 | Fluorine-based resin | Carbonate-based | 120 | 30 | — | — | — |
| | | urethane resin | | | | | |
| 17 | — | Carbonate-based | 120 | — | — | — | — |
| | | urethane resin | | | | | |

In the table, the content ratio of the first resin represents a proportion of the mass of the first resin with respect to a total mass of the first resin and the second resin.

“Silicon atom proportion (200 nm)” represents a proportion of silicon atoms with respect to a sum of carbon atoms, nitrogen atoms, oxygen atoms, and the silicon atoms in a region having a start point that is the outer surface of the transfer member surface layer and an end point that is a position of 200 nm in the thickness direction of the transfer member surface layer from the outer surface. “Silicon atom proportion (Outer Surface)” represents a proportion of silicon atoms to a sum of carbon atoms, nitrogen atoms, oxygen atoms, and silicon atoms on the outer surface of the transfer member surface layer.

“0.2X-0.8X Structure” represents a structure observed in a region having a start point that is the position of 0.2X from the outer surface of the transfer member surface layer and an end point that is the position of 0.8X from the outer surface, where X is the thickness of the transfer member surface layer. A description of “Domain-matrix” represents that a domain-matrix structure was observed in the region described above.

In all the intermediate transfer belts in which the domain-matrix structure was observed, it was checked that the domain comprised the first resin.

### Example 1

Four manufactured electrophotographic photosensitive members 1 and the intermediate transfer belt 1 were mounted in a full color electrophotographic image forming apparatus (trade name: ImagePRESS C10000VP, manufactured by Canon Inc.) and the following evaluations were performed.

### Evaluation of Embossed Transferability

The above-described image forming apparatus was operated under an environment of temperature 23° C. and relative humidity of 5% to output one sheet of a full-surface secondary color solid-image of cyan and magenta on A4 size embossed paper (trade name: RESAK 66, 250 g/m², manufactured by Special Tokai Paper Co.), and the image unevenness was visually checked. The degree of image unevenness was evaluated in accordance with the following criteria.
Rank A: No image unevenness image was observed, and the result was satisfactory
Rank B: Slight image unevenness is present in a part of concave portions of the embossed paper
Rank C: Image unevenness is present in an area of about 10% of concave portions of the embossed paper
Rank D: Image unevenness is present in an area of about 30% of concave portions of the embossed paper

In the cases of Ranks A to C, the emboss transferability was judged good. The evaluation results are represented in Table 4.

### Evaluation of Emboss Transferability During Repeated Use

Under the environment described above, image formation was repeated for 10,000 sheets using character images with a printing ratio of 1% by using ordinary paper of size A4. During that time, one sheet of full-surface secondary color solid image of cyan and magenta was output under the same conditions described above for every 1000 sheets, and the image unevenness of the solid image was visually checked. The degree of image unevenness was evaluated in accordance with the following criteria.
Rank A: No image unevenness was observed in all the images, and the results were satisfactory.
Rank B: In one or more sheets of images, there is slight image unevenness in a part of concave portions of the embossed paper.
Rank C: In one or more sheets of images, image unevenness is present in an area of about 10% of concave portions of the embossed paper.
Rank D: In one or more sheets of images, image unevenness is present in an area of about 30% of concave portions of the embossed paper.

In the case of Ranks A to C, the emboss transferability at the time of repeated use was judged good. The evaluation results are represented in Table 4.

### Examples 2 to 16 and Comparative Examples 1 and 2

The image forming apparatuses were evaluated in the same manner as in Example 1 except that the types of the electrophotographic photosensitive member and the intermediate transfer belt were changed as represented in Table 4. The evaluation results are represented in Table 4.

TABLE 4

| | | | | | | | | Emboss |
|---|---|---|---|---|---|---|---|---|
| | Electrophotographic | | Content | Silicon atom | Silicon atom | | | transferability |
| | photosensitive | Intermediate | ratio | proportion | proportion | | Emboss | (during |
| | member | transfer belt | of first resin | (200 nm) | (outer surface) | 0.2X-0.8X | transferability | repeated |
| | No. | No. | (% by mass) | (atomic %) | (atomic %) | Structure | (initial period) | use) |
| Example 1 | 1 | 1 | 30 | 0.3~40.0 | 23.0 | Domain-matrix | A | A |
| Example 2 | 1 | 2 | 30 | 0.3~40.0 | 20.2 | Domain-matrix | B | A |
| Example 3 | 1 | 3 | 30 | 0.2 | 28.1 | Domain-matrix | B | A |
| Example 4 | 1 | 4 | 30 | 0.3 | 26.8 | Domain-matrix | A | A |
| Example 5 | 1 | 5 | 70 | 40.0 | 39.7 | Domain-matrix | B | A |
| Example 6 | 1 | 6 | 70 | 41.0 | 41.0 | Domain-matrix | C | A |
| Example 7 | 1 | 7 | 20 | 0.3~40.0 | 0.2 | Domain-matrix | B | A |
| Example 8 | 1 | 8 | 20 | 0.3~40.0 | 15.1 | Domain-matrix | A | A |
| Example 9 | 1 | 9 | 15 | 0.3~40.0 | 18.0 | Domain-matrix | B | A |
| Example 10 | 1 | 10 | 20 | 0.3~40.0 | 20.1 | Domain-matrix | B | A |
| Example 11 | 1 | 11 | 50 | 0.3~40.0 | 28.0 | Domain-matrix | A | A |
| Example 12 | 1 | 12 | 80 | 0.3~40.0 | 37.0 | Domain-matrix | A | A |
| Example 13 | 1 | 13 | 85 | 0.3~40.0 | 39.8 | Domain-matrix | B | A |
| Example 14 | 1 | 14 | 30 | 0.1 | 35.3 | — | B | B |
| Example 15 | 2 | 1 | 30 | 0.3~40.0 | 23.0 | Domain-matrix | A | A |
| Example 16 | 1 | 15 | 30 | 0.3~40.0 | 20.0 | Domain-matrix | B | A |
| Comparative | 1 | 16 | 30 | — | — | — | D | D |
| Example 1 | | | | | | | | |
| Comparative | 1 | 17 | — | — | — | — | D | D |
| Example 2 | | | | | | | | |

As the results of the evaluations, in Examples 1 to 16, the emboss transferability was good, and excellent emboss transferability was maintained even at the time of repeated use. In Comparative Examples 1 and 2, the emboss transferability was inferior to that of Example 1, and the deterioration of transferability could not be suppressed even at the time of repeated use.

Although not illustrated in the table, after the repeated image formation for 10,000 sheets, the remaining film thicknesses of the surface layers of the electrophotographic photosensitive members used in Examples 1 and 15 were measured, and the electrophotographic photosensitive members used in Example 1 were thicker than those used in Example 15. This represents that the electrophotographic photosensitive member 1 of which the ratio of C/(Si+C) is 0.95 or more is superior in wear resistance.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-024533, filed Feb. 18, 2025, and Japanese Patent Application No. 2025-201776, filed Nov. 21, 2025, which are hereby incorporated by reference herein in their entirety.

What is claimed is:

1. An image forming apparatus comprising:
an electrophotographic photosensitive member;
charging means for charging a surface of the electrophotographic photosensitive member;
image exposing means for forming an electrostatic latent image on the surface of the electrophotographic photosensitive member by emitting image exposure light to the surface of the charged electrophotographic photosensitive member;
toner;
developing means for forming a toner image on the surface of the electrophotographic photosensitive member by developing the electrostatic latent image by using the toner;
transfer means for transferring the toner image from the surface of the electrophotographic photosensitive member to a transfer member; and
cleaning means for removing residual toner remaining on the surface of the electrophotographic photosensitive member,
wherein the electrophotographic photosensitive member has a photosensitive member surface layer formed of amorphous silicon carbide or amorphous carbon,
wherein, in a surface region A that is a region near the surface from the surface of the photosensitive member surface layer to a depth of 100 nm, a ratio of the number of carbon atoms to a sum of the number of carbon atoms and the number of silicon atoms is 0.85 or more,
wherein the transfer member is an intermediate transfer belt comprising a substrate layer, an elastic layer, and a transfer member surface layer,
wherein the transfer member surface layer comprises a first resin and a second resin,
wherein the first resin comprises at least one selected from the group consisting of a silicone-acrylic polymer having a silicone segment and an acrylic polymer segment; and a silicone-vinyl acetate polymer having a silicone segment and a vinyl acetate polymer segment; and
wherein the second resin comprises a urethane resin.

2. The image forming apparatus according to claim 1,
wherein the first resin comprises the silicone-acrylic polymer.

3. The image forming apparatus according to claim 2,
wherein the silicone-acrylic polymer is a graft polymer comprising the acrylic polymer segment as a main chain and the silicone segment as a side chain.

4. The image forming apparatus according to claim 1,
wherein the first resin comprises the silicone-vinyl acetate polymer.

5. The image forming apparatus according to claim 4,
wherein the silicone-vinyl acetate polymer is a graft polymer comprising the silicone segment as a main chain and the vinyl acetate polymer segment as a side chain.

6. The image forming apparatus according to claim 1,
wherein, in a region having a start point that is an outer surface of the transfer member surface layer and an end point that is a position of 200 nm in a thickness direction of the transfer member surface layer from the outer surface,
when a proportion of silicon atoms with respect to a sum of carbon atoms, nitrogen atoms, oxygen atoms, and the silicon atoms is measured using depth analysis of X-ray photoelectron spectroscopy,
the proportion of the silicon atoms is 0.3 to 40.0 atomic %.

7. The image forming apparatus according to claim 1,
wherein, in an outer surface of the transfer member surface layer,
when a proportion of silicon atoms with respect to a sum of carbon atoms, nitrogen atoms, oxygen atoms, and the silicon atoms is measured using X-ray photoelectron spectroscopy,
the proportion of the silicon atoms is 15.0 to 40.0 atomic %.

8. The image forming apparatus according to claim 1,
wherein a ratio of the number of carbon atoms to a sum of the number of the carbon atoms and the number of silicon atoms in the surface region A is 0.95 or more, and
wherein a content ratio of the first resin in the transfer member surface layer is from 20 to 80% by mass with respect to a total mass of the first resin and the second resin.

9. The image forming apparatus according to claim 1,
wherein, in cross-section observation of the transfer member surface layer,
when a thickness of the transfer member surface layer is denoted by X,
in a region having a start point that is a position of 0.2X from the outer surface of the transfer member surface layer and an end point that is a position of 0.8X from the outer surface, a domain-matrix structure in which domains are dispersed in a matrix is observed,
the matrix comprises the second resin, and
the domains comprise the first resin.
